(19) United States
(12) Patent Application Publication
(10) Pub. No.: US 2005/0114216 A1
(43) Pub. Date: May 26, 2005

(54) Bagging carousel

(75) Inventors: David B. Lantz, Royston, GA (US); Mark W. Dykgraaf, Parchment, MI (US)

Correspondence Address: HOWSON AND HOWSON;ONE SPRING HOUSE CORPORATION CENTER, BOX 457, 321 NORRISTOWN ROAD, SPRING HOUSE, PA, 19477, US

(73) Assignee: Royston LLC, Jasper, GA (US)

(21) Appl. No.: 10/996,154

(22) Filed: Nov. 23, 2004

Related U.S. Application Data
(60) Provisional application No. 60/524,545, filed on Nov. 24, 2003.

(51) Int. Cl. G06F 17/60

(52) U.S. Cl. 705/16

(57) ABSTRACT

A checkout system in a retail store check-out counter, includes a bagging carousel positioned adjacent a checkout module. The bagging carousel includes a base, and a rotatable support surface mounted to the base. Extending upwardly from the rotatable support surface are a plurality of bag supports, each of which is adapted to support at least one bag. The bag supports are rotatable with the rotatable support surface about the base between a filling position, where a checkout clerk may fill one or more bags supported by the bag supports, and an unloading position where the bag or bags may be unloaded from the carousel by the customer. The bagging carousel includes a user interface device to permit a user to view, and/or enter, information relating to the transaction.

### CROSS REFERENCE TO RELATED APPLICATION

This application claims the benefit, under 35 U.S.C. §119(e), of provisional application 60/524,545, filed Nov. 24, 2003.

### TECHNICAL FIELD AND BACKGROUND OF THE INVENTION

The present invention generally relates to a bagging carousel and, more particularly, to a bagging carousel that is suitable for use in a checkout system, such as a checkout system used at a retail store, such as a grocery store or the like.

### SUMMARY OF THE INVENTION

The bagging carousel of the present invention provides a continuous feed or throughput of at least partially filled bags to a customer by providing a system that allows a checkout clerk to fill a bag and then transfer the filled bag to a customer and, optionally, fill another bag after the first bag is transferred to the customer. In addition, the bagging carousel provides either an additional work surface or a mount for a customer interface device.

In one form of the invention, a checkout system of the present invention includes a front checkout module and a bagging carousel, which is positioned adjacent the checkout module. The bagging carousel includes a base and a rotatable support surface, which is mounted to the base. Extending upwardly from the rotatable support surface is a plurality of bag supports, each of which is adapted for supporting at least one bag. The bag supports are rotatable with the rotatable support surface about the base between a filling position, where a checkout clerk may fill one or more bags supported by the bag supports, and an unloading position where the bag or bags may be unloaded from the carousel by, for example, the customer. In addition, the bagging carousel includes a user interface device to permit a user to view information and/or enter information relating to the transaction.

In one aspect, the user interface device comprises a display monitor, which displays information relating to the transaction. Alternately, the user interface device may comprise an input device, which allows a customer to input information relating to the transaction, for example payment information.

In a further aspect, the user interface device is adjustable. For example, the user input device may be mounted on an extendible support so that the user interface device may be raised or lowered with respect to the bag supports or may be tilted to adjust the angle of the user interface device for the convenience of the customer.

In a further aspect, the bagging carousel includes a hub, which may be either in the form of a wire frame, or a drum, with the bag supports extending from the hub. The bag supports are preferably disposed in a uniform, circumferentially spaced arrangement on the hub, and have arms that extend outward, in a direction away from the axis of rotation of the hub. Preferably, each bag support comprises two arms, both extending outward and in substantially parallel relationship to each other, and in substantially parallel relationship to an imaginary radius extending through the axis of rotation of the bag support and situated midway between the two arms.

In a preferred form, the bagging carousel includes a support surface supported on the hub to provide an additional support or work surface.

In other aspects, the bag supports comprise wire members, such as U-shaped wire members with a pair of projecting arms, which are particularly suitable for supporting plastic bags.

According to another form of the invention, a checkout system includes a front module and a bagging carousel. The bagging carousel includes a base and a rotatable support surface, which is supported on the base. A hub is mounted to the rotatable support surface, which includes a plurality of bag supports. The carousel further includes a support, which provides either a work surface or a mounting or support surface above the hub.

In one aspect, the support provides a work surface, for example, which is suitable for use as a check-writing surface. In another aspect, the support provides a mounting surface for mounting a user interface device to the support. For example, the user interface device may comprise a display monitor and/or a user input device to allow a customer to view and/or input information relating to the transaction.

In one aspect, the front module includes a conveyor for conveying items.

As will be appreciated from the foregoing, the present invention provides a bagging carousel that permits a checkout clerk to fill and then deliver a filled or partially filled bag to the customer and, further, provide a substantially continuous feed of filled or at least partially filled bags from a checkout clerk to a customer with minimal handling of the bags. Furthermore, the bagging carousel permits the customer to have access to an input and/or a viewing device, which allows the customer to input and/or view information relating to the transaction. These and other object, advantages, purposes, and features of the invention will become more apparent from the study of the following description taken in conjunction with the drawings.

### DESCRIPTION OF DRAWINGS

FIG. 1 is a perspective view of a checkout system incorporating a bagging carousel of the present invention;

FIG. 2 is a second perspective view of the checkout system of FIG. 1;

FIG. 3 is another perspective view of the checkout system of FIG. 1;

FIG. 4 is a plan view of the checkout system of FIGS. 1-3;

FIG. 5 is an elevation view of the checkout system of FIG. 4;

FIG. 6 is an exploded perspective view of the bagging carousel;

FIG. 7 is a perspective view of the bag support assembly of the bagging carousel;

FIG. 8 is a plan view of the bag support assembly of FIG. 7;

FIG. 9 is a side elevation view of the bag support assembly of FIG. 7;

FIG. 10 is another side elevation view of the bag support assembly;

FIG. 11 is an elevation view of the carousel support;

FIG. 12 is an exploded perspective view of the support of FIG. 11;

FIG. 13 is an elevation view of a second embodiment of a carousel support of the present invention;

FIG. 14 is a side elevation view of the support of FIG. 13;

FIG. 15 is a plan view of the support of FIG. 13;

FIG. 16 is a plan view of a second embodiment of a checkout system incorporating a bagging carousel of the present invention;

FIG. 17 is an elevation view of the checkout system of FIG. 16;

FIG. 18 is an exploded perspective view of the rotatable support surface and bag support assembly of an alternative embodiment of the invention; and

FIG. 19 is a top plan view of the assembly of FIG. 18.

### DETAILED DESCRIPTION OF THE PREFERRED EMBODIMENTS

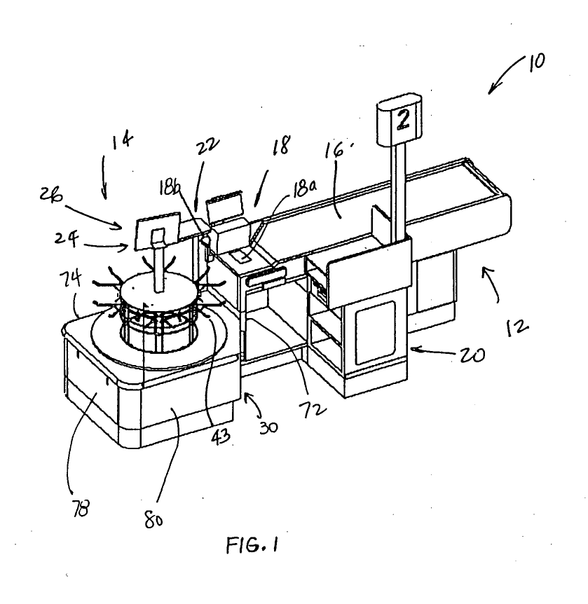

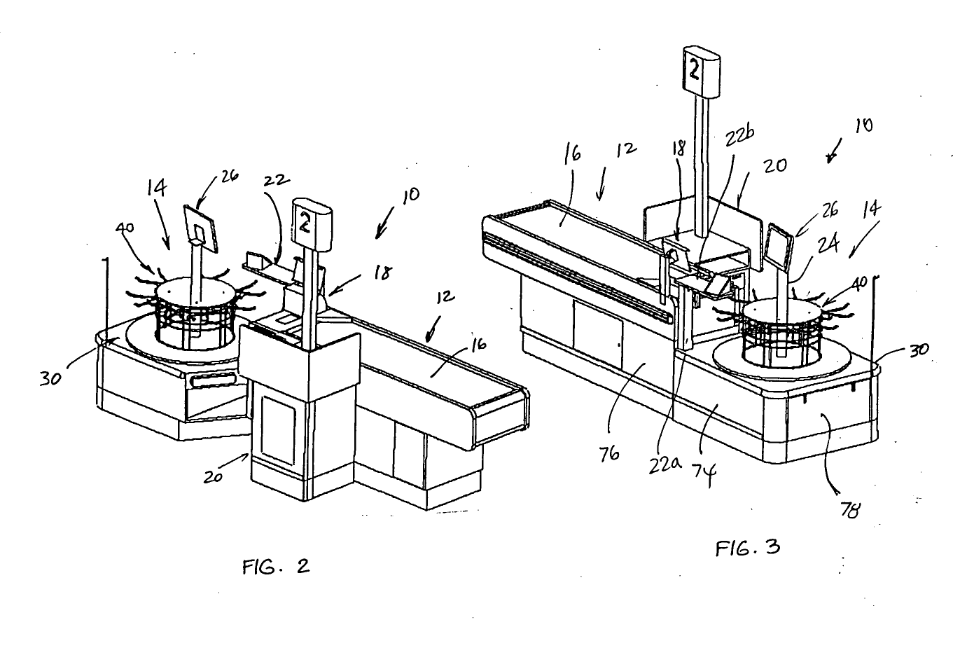

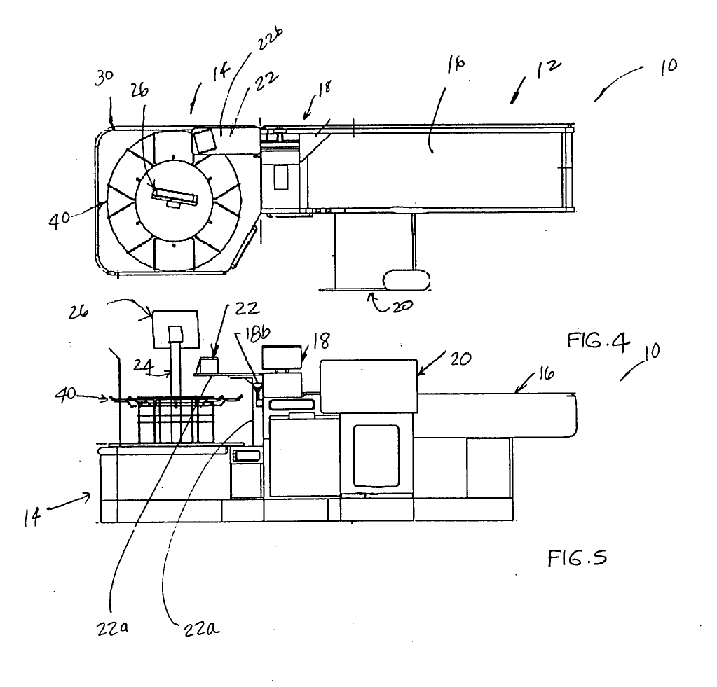

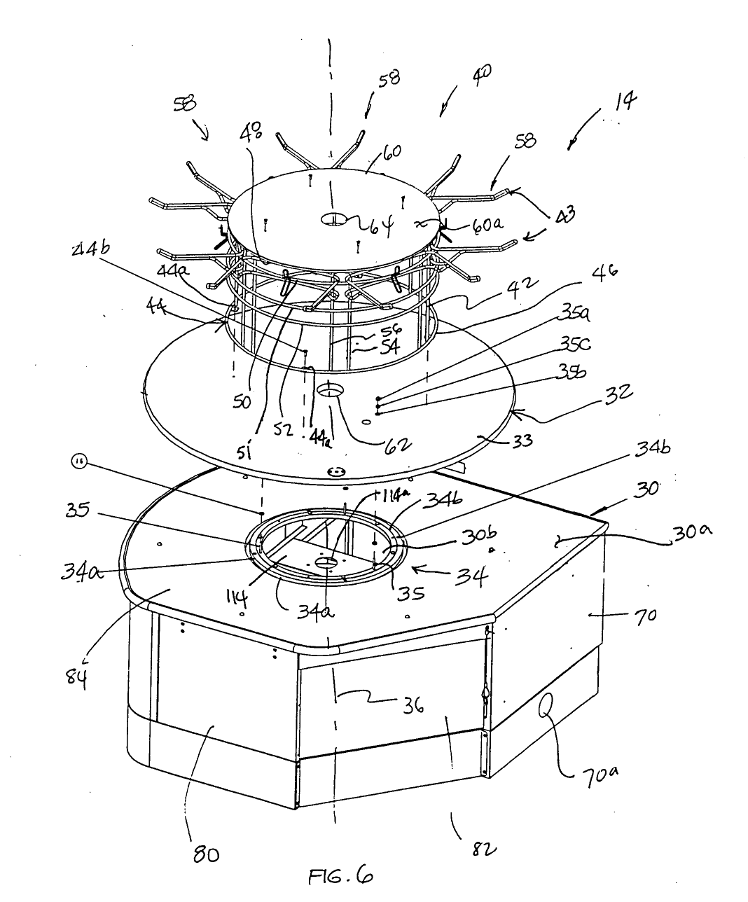

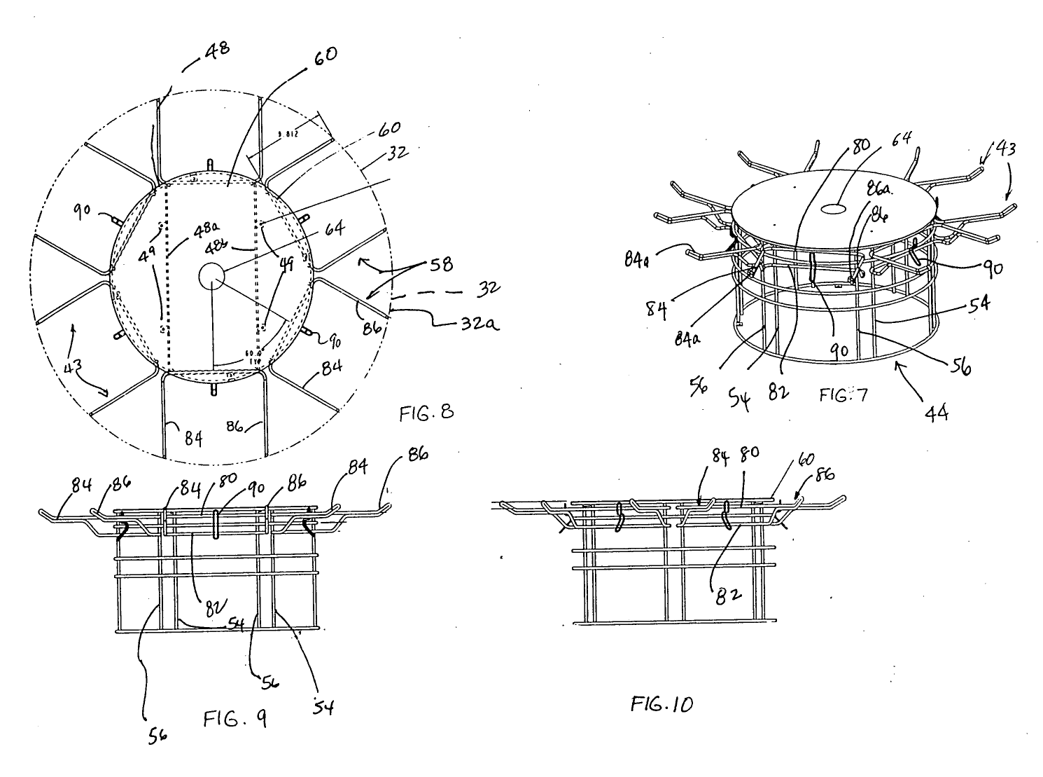

Referring to FIGS. 1-5, the numeral 10 generally designates a checkout system that incorporates a bagging carousel 14 of the present invention. Checkout system 10 is suitable for use in a retail store, such as a grocery store or the like, and includes a front checkout module 12 and bagging carousel 14. As will be more fully described below, bagging carousel 14 is positioned adjacent the discharge end of the checkout module so that a checkout clerk can transfer a filled or partially filled bag and, more preferably, provide a feed of filled or at least partially filled bags to a customer that is standing adjacent the bagging carousel.

Front checkout module 12 includes a conveyor 16, a scanning assembly 18, and a cash register stand 20. Although illustrated as a module, any of these components,—the conveyor, scanning assembly, and register stand—may comprise separate units. Further, checkout module 12 may include or be grouped with other components. Bagging carousel 14 is positioned adjacent the scanning assembly so that, after an item is scanned by scanning assembly 18, a checkout clerk may place the scanned item in a bag supported by bagging carousel 14. In the illustrated embodiment, scanning assembly 18 includes a planar fixed scanner 18a positioned adjacent the end-of conveyor 16 and a hand-held scanning unit 18b, which is positioned adjacent the planar fixed scanner. However, it should be understood that bagging carousel 14 may be used with checkout modules with other configurations and components.

Positioned adjacent scanning assembly 18 is check-writing stand 22, which provides a work surface to a customer who is typically standing adjacent bagging carousel 14. Check-writing stand 22 includes a vertical support member 22a and a horizontal plate 22b. Horizontal plate 22b provides a work surface and optionally, includes an input device, such as a touch screen, a keypad or card reader, to allow the customer to enter payment for the transaction. Support 22a is mounted to and extends upwardly from carousel 14 adjacent scanning assembly 18. Furthermore, as will be more fully described below, bagging carousel 14 includes an extendable support 24, which allows another user interface device 26 (or a Work surface) to be provided on bagging carousel 14 for use by the customer.

User interface device 26 may comprise a display monitor, which displays information about the transaction, for example, including a list of items purchased and their respective purchase prices. Alternately, user interface device 26 may comprise a user input device, such as a touch screen, a keypad, or a card reader, to allow a purchaser to input information relating to the transaction, for example, payment information, including credit card information. Alternately, the user interface device may include both an input device and a display device so that the customer may view information about the transaction and, further, provide input to the transaction, such as payment.

Referring to FIG. 6, bagging carousel 14 includes a base 30 and a rotatable support surface 32, which is rotatably mounted on base 30 by a bearing assembly 34, such as an annular bearing assembly, such as used in a Lazy Susan. Bearing assembly 34 includes a fixed annular member 34a and a movable annular member 34b, which is rotatably supported on the fixed annular member 34a by a plurality of bearings. In the illustrated embodiment, rotatable support surface 32 comprises a circular table or plate member 33, which is mounted to the rotatable annular member 34b by a plurality of fasteners 35, which extend upwardly from annular member 34b and are secured to plate 33 by nuts and washers, including a lock washer, 35a, 35b, 35c, respectively. In this manner, plate 33 rotates with upper annular member 34b about a vertical axis 36, which extends through base 30.

Mounted to plate 33 is a bag support assembly 40 that is formed from a plurality of wire members 42, which are arranged to form an annular frame 44 and a plurality of bag supports 43. Frame 44 includes a lower annular wire frame member 46 and an upper annular wire frame member 48 and a plurality of intermediate annular wire frame members 50,51, and 52, which interconnect vertical frame members 54 and 56 to thereby form annular frame 44. Mounted to frame 44 are a plurality of generally U-shaped wire members 58, which form bag supports 43 for bags, such as plastic bags. U-shaped wire members 58 are arranged in a radial pattern around frame 44 so that bag carousel 14 may support a plurality of bags. Frame 44 includes a plurality of mounting tabs 44a with mounting openings for receiving fasteners 44b that secure frame 44 to rotatable plate 33 so that frame 44 and bag supports rotate with rotatable plate 33. In this manner, a checkout clerk may fill one or more bags and, thereafter, reposition the bags by rotating rotatable plate 33 to move the filled bag or bags to a position where a customer may retrieve the bags and, for example, then place them in his or her shopping cart.

In addition, frame 44 preferably includes an upper plate member 60, which is mounted to upper annular wire frame member 48, to provide additional support surface, for example, for items that are not to be bagged, such as small loose items, such as packages of gum or cigarettes, or heavier items, such as bottles, including milk bottles. In the illustrated embodiment, upper annular wire member 48 of frame 44 includes a pair of transverse members 48a and 48b that include mounting tabs 49 for securing plate 60 to frame 44. However, it should be understood that upper annular wire member 48 may include inwardly projecting tabs for mounting plate 60 to frame 44.

As previously noted, carousel 14 includes a work surface, such as a check writing surface. In the illustrated embodiment, support 24 is mounted to base 30 and extends upwardly through plate 33 through a transverse opening 62 and, further, through frame 44 and upper plate 60 through transverse opening 64 to thereby support user interface device 26 or a work surface above support surface 60a of plate 60. Preferably, support 24 is anchored in base 30 and, therefore, does not rotate with rotatable plate 33 so that the work surface or input interface device is stationary and independent of the position the bag supports.

As best understood from FIGS. 1-6, base 30 includes a plurality of sidewalls with a f1fSt sidewall 70 for positioning adjacent the end wall 72 of front module 12, a second sidewall 74 for aligning with the sidewall 76 of front module 12, an end wall 78, which may define the end of the conveyor system 10. In this manner, bagging carousel 14 appears to be an integral part or an extension of front checkout module 12. However, it should be appreciated that other components may be positioned adjacent end wall 78. Base 30 also includes a sidewall 80, which is opposed from sidewall 74 and which is connected to sidewall 70 by an angled sidewall 82 to reduce the footprint of the base to increase the available space for the checkout clerk. Bearing assembly 34 is mounted in a top wall 84 of base 30, which is supported by the respective sidewalls and, further, secured thereto, for example, by fasteners or the like.

Referring to FIGS. 7-10, as previously noted, bag supports 58 comprise U-shaped wire members. As best seen in FIGS. 7-10, each support is formed from an upper horizontal wire member 80 and a lower horizontal member 82, which are respectively mounted to vertical support members 54 and 56. Projecting from upper horizontal member 80 and lower horizontal member 82 are a pair of outwardly extending horizontal members or arms 84 and 86, which have upwardly turned distal ends 84a and 86a. Arms 84 and 86 are formed by a section of the wire member that is bent in a Y-shaped configuration, with the 360° bend of the wire member forming the distal ends of the arms and with the separated sections returning to and being integral or fixed with member 80 and member 82. Optionally, lower horizontal member 82 includes a hook member 94. In this manner the handles of a bag, such as a plastic bag, may be draped over arms 84 and 86 to open the top end of the bag for filling the bag, with the weight of the items placed in the bag securing the bag on arms 84 and 86 and upwardly turned distal 84a and 86a holding the handles from slipping off the arms.

In the illustrated embodiment, bagging carousel 14 includes six bag supports, with each bag support spaced substantially evenly around frame 44. It should be understood that the number of bag supports may be increased or decreased. Similarly, the number of vertical and annular wire frame members forming frame 44 may be increased or decreased as desired. In addition, in the illustrated embodiment, the length of arms 84 and 86 are generally sized such that their distal ends 84a and 86b extend to the perimeter 33a of plate 33. In this manner, when a bag is mounted between their respective arms 84 and 86 of bag supports 43, support plate 33 will provide a support surface for the bottom ends of the respective bags when the bags are filled with items.

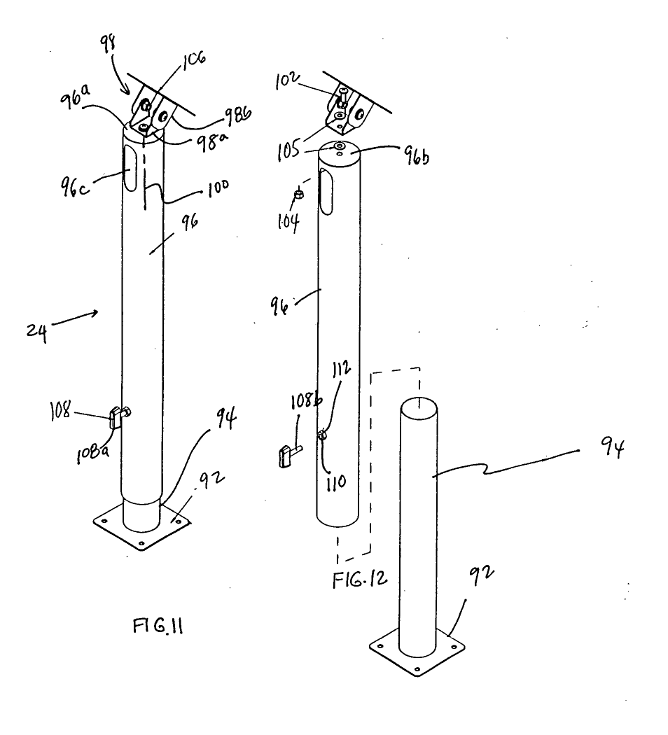

As previously noted, module 14 preferably includes a support 24 for mounting user interface device 26 to module 14, or for providing an additional work surface, such as a check-writing surface. As best seen in FIGS. 11 and 12, support 24 includes a base 92 for attachment to base 30, a fixed inner tubular member 94, and an outer tubular member 96, which is positioned over inner tubular member 94. A bracket 98 is mounted to upper end 96a of tubular member 96, which provides a mounting surface for user interface device 26. Bracket 98 preferably provides an adjustable mounting surface and includes a fixed base 98a and a movable mounting portion 98b on which user interface device 26 is mounted. Optionally, bracket 98 may be rotatably mounted to tubular member 96 about a vertical pivot axis 100, for example, by a pivot bolt 102, which mounts base 98a to upper wall 96b of tubular member 96 and which is secured therein by a nut 104. In this manner, bracket 98 provides a swivel connection to tubular member 96. Mounting portion 98b includes a pair of mounting ears, which mount to the respective upwardly extending ears of base 98a by a pair of fasteners, and a mounting flange 106 to which the user interface device is mounted. In this manner, bracket 98 also provides a tilt adjustment for the user interface device.

The vertical position of tubular member 96 is fixed in position with respect to tubular member 94 by a knob 108, which includes a handle portion 108a and a projecting pin 108b that extends through an opening 110 provided in tubular member 96 and, further, which threadingly engages a nut 112 mounted to tubular member 96 so that when handle 108a is rotated, pin 108b will be urged into frictional engagement with tubular member 94 to thereby fix the position of tubular member 96 with respect to tubular member 94. Furthermore, tubular member 94 may incorporate recesses into which pin 108b is extended to provide a detent mechanism to fix the position of tubular member 96 in one or more discrete positions along tubular member 94. Similarly, to release engagement so that tubular member 96 can be raised with respect to tubular member 94, handle 108 is simply rotated in the other direction. Alternately, where a detent mechanism is provided, pin 108b may be biased by a spring to engage a respective recess on tubular member 94, with pin 108 disengaged by simply pulling handle 108 outwardly against the biasing force of the spring. It should be understood that the support may incorporate a spring or a cylinder, such as an air cylinder, to assist or power the movement of outer tube 96.

Referring again FIG. 6, base 92 of support 24 is mounted to base 30 on a mounting plate 114, which is secured in base 30 below the top wall 84 in the cavity defined by sidewalls 70, 74, 78, 80, and 82 and which is aligned with opening 30b of base 30. To provide communication between the user interface device and the checkout system (the scanning assembly 18 and the register (not shown)), sidewall 70 includes an opening 70a which permits the respective cables or wires to enter bagging carousel 14 and, further, to be directed through opening 114a of mounting plate 114 through base plate 92 and through the respective tubular members 94 and 96 with the cables and/or wires connecting to the respective user interface device through an opening 96c of tubular member 96.

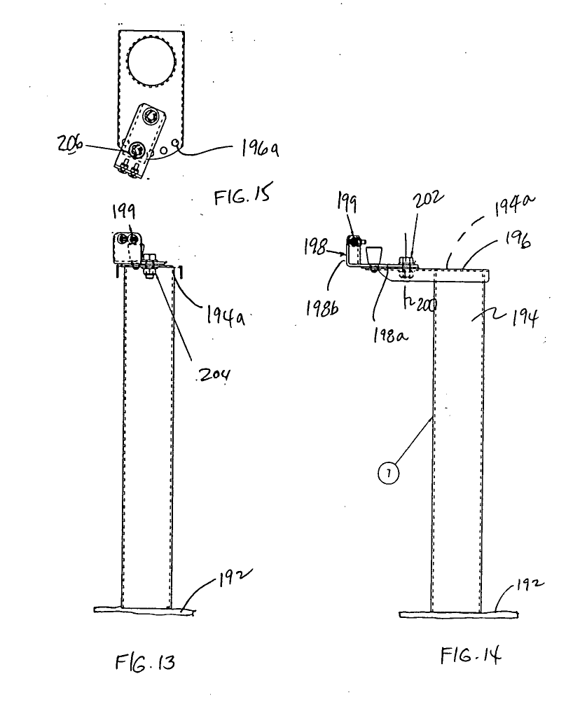

Referring to FIG. 13-15, the numeral 124 designates another embodiment of the support of the bagging module of the present invention. Support 124 includes a base 192 for attachment to base 30, a tubular member 194, which is mounted to base 192, and a mounting plate 196, which is mounted to the upper end of tubular member 194. A bracket 198 is mounted to upper end 194a of tubular member 194, which provides a mounting surface for user interface device 26. Bracket 198 preferably provides an adjustable mounting surface and comprises an L-shaped member with a flange 198a that is pivotally mounted to plate 196 and a second flange 198b to which the user interface device is mounted by fasteners 199. Flange 198a is pivotally mounted to plate 196 about a vertical pivot axis 200, for example, by a pivot bolt 202, which mounts flange 198a to plate 196 and which is secured therein by a nut 204. Plate 196 includes a plurality of recesses or openings 196 into which a spring loaded plunger 206 is extended to fix the position of bracket 198 about axis 200. In this manner, bracket 198 provides a swivel connection to tubular member 194. In the illustrated embodiment, the angular range of the swivel connection is approximately ninety degrees and further provides discrete, indexed positions in contrast to the previous embodiment that provided a 360 degree swivel connection and, further, with an infinite number of positions; however, it should be understood that the range of motion for bracket 198 may be increased (or decreased) by increasing the size of plate 196 or decreasing the distance between the plunger and the pivot bolt, as would be understood by those skilled in the art. Further, the number of positions may be increased (or decreased) by adjusting the number of recesses or openings.

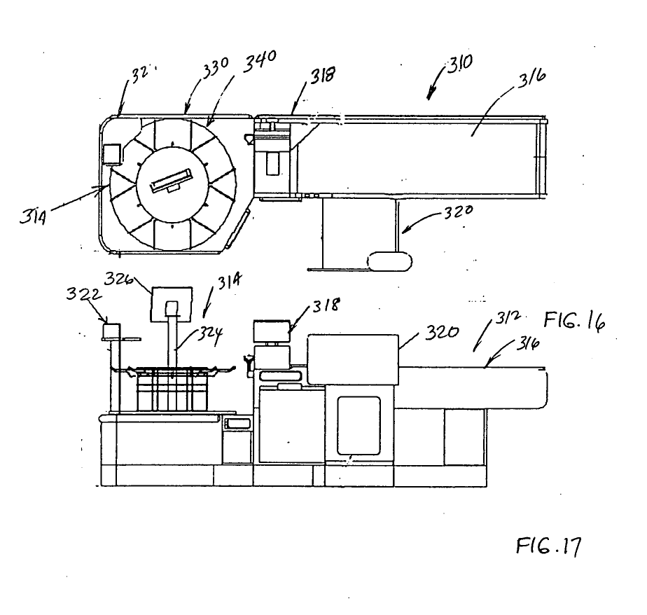

Referring to FIGS. 16 and 17, the numeral 310 designates another embodiment of the checkout system of the present invention. Checkout system 310 is similar to checkout system 10 and includes a checkout module 312 and a bagging carousel 314. Checkout module 312 is similar to checkout module 12 and includes a conveyor 316, a scanning assembly 318, and a register stand 320. Carousel 314 is similarly positioned at the discharge end of module 312 adjacent scanning assembly 318.

In the illustrated embodiment, bagging carousel 314 incorporates a check-writing surface, which is provided by a check-writing stand 322 that is mounted to base 330 of carousel 314 on an opposed side of base 330 than stand 22 in the previous embodiment. In this manner, a customer may have a better view of articles being placed in the bags and a checkout clerk will have more room to maneuver the articles being loaded in to the bags.

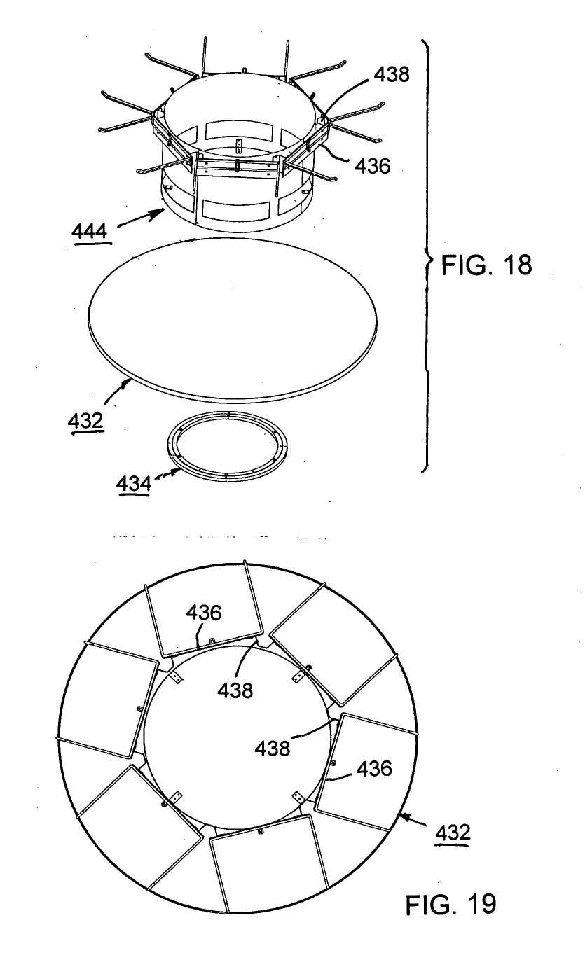

Referring now to FIGS. 18 and 19, in an alternative embodiment of the carousel, a rotatable support surface 432 is mounted for rotation on an annular bearing assembly 434. The hub, however, is in the form of a drum 444, which is preferably formed by bending a sheet of steel into a cylinder and welding its meeting edges together. The drum is coaxial with the axis of rotation of the support surface 432, and, as shown in FIG. 18, the drum may be provided with apertures for weight reduction as well as for access to brackets by which it is secured to the rotatable support surface 432.

Plates 436 are connected to the upper part of the drum by brackets 438 (see FIG. 18), and bag support wires are fastened to, and extend outwardly from, the plates 436. The drum provides a simpler hub, which can be stronger than the wire frame previously described.

While several forms of the invention have been shown and described, other forms will now be apparent to those skilled in the art. For example, the support assembly may be made from components other than wire members, including plastic or wood members or a combination thereof. Therefore, it will be understood that the embodiments shown in the drawings and described above are merely for illustrative purposes, and are not intended to limit the scope of the invention, which is defined by the claims which follow, as interpreted under the principles of patent law including the doctrine of equivalents.

1. A checkout system comprising:
a front checkout module;
a bagging carousel, said bagging carousel including a base and a support surface rotatable about an axis of rotation, said support surface being mounted to said base and including a plurality of bag supports, each of said bag supports adapted for supporting at least one bag, said bag supports being rotatable with said rotatable support surface about said base between a filling position, where a checkout clerk may fill a bag supported by a respective bag support, and an unloading position where said respective bag may be unloaded from said bag support; and
a user interface device mounted at said carousel between said bag supports to permit a user to view information and/or enter information relating to the transaction.

2. The checkout system according to claim 1, wherein said user interface device comprises a display monitor, said display monitor displaying information relating to the transaction.

3. The checkout system according to claim 1, wherein said user interface device comprises an input device, said input device allowing a customer to input information relating to the transaction.

4. The checkout system according to claim 1, wherein a position of said user interface device is adjustable.

5. The checkout system according to claim 4, further comprising an extendible support, said user interface device mounted to said extendible support wherein said user interface device may be raised or lowered with respect to said bag supports.

6. The checkout system according to claim 1, wherein said bagging carousel includes a hub, said bag supports extending from said hub.

7. The checkout system according to claim 6, wherein said bag supports are arranged in a uniform, circumferentially spaced arrangement about said hub to provide a plurality of uniform, spaced, bag holding positions.

8. The checkout system according to claim 6, further comprising a support surface supported on said hub to provide a work surface.

9. The checkout system according to claim 1, wherein said bag supports comprise wire members.

10. The checkout system according to claim 6, wherein said hub comprises a cylindrical drum, and wherein said bag supports comprise wire members connected to, and extending outward from said cylindrical drum.

11. A checkout system comprising:
a checkout module; and
a bagging carousel, said carousel including a base, a support surface supported on said base and rotatable about an axis of rotation, and a hub mounted to said rotatable support surface, said hub including a plurality of bag supports, said carousel further including a support supported in said hub and extending from said hub to provide one of a support surface and a mounting surface.

12. The checkout system according to claim 11, wherein said support provides a support surface.

13. The checkout system according to claim 11, wherein said support provides a mounting surface for mounting a user interface device.

14. The checkout system according to claim 13, further comprising a user interface device mounted to said mounting surface.

15. The checkout system according to claim 14, wherein said user interface device comprises a display monitor.

16. The checkout system according to claim 14, wherein said user interface device comprises an input device.

17. The checkout system according to claim 11, wherein said module includes a conveyor.

18. The checkout system according to claim 11, wherein said module includes a scanning assembly, said carousel positioned adjacent said scanning assembly.

19. The checkout system according to claim 11, wherein said support comprises an extendible support.

20. The checkout system according to claim 11, wherein said hub comprises a cylindrical drum coaxial with said axis of rotation, and wherein said bag supports comprise wire members connected to, and extending outward from said cylindrical drum.
